(19) United States
(12) Patent Application Publication
(10) Pub. No.: US 2012/0246941 A1
(43) Pub. Date: Oct. 4, 2012

(54) GARDEN SHEARS

(76) Inventor: Mei-Yu Nien, Changhua City (TW)

(21) Appl. No.: 13/075,171

(22) Filed: Mar. 29, 2011

(51) Int. Cl. A01G 3/02

(52) U.S. Cl. 30/243

(57) ABSTRACT

Garden shears has a cutting member with an inverted U-shaped opening for accepting the target object. When the driving member is pushed towards the handle, the target object A in the opening is and pushed and cut off by the cutting edge portion of the blade. Therefore, the target object can be securely limited by the garden shears without sliding off.

### BACKGROUND OF THE INVENTION

1. Field of the Invention

The present invention relates to a garden shears, and more particularly to garden shears in which the cutting member has an inverted U-shaped opening for accepting a target object, which can prevent the target object from slipping off.

2. Description of the Related Art

Currently, typical garden shears 50, as shown in FIG. 8, have: a pair of opposite cutting members 51, 52 pivoted together by a pivoting shaft 53, with the two cutting members 51, 52 respectively having a cutting edge portion 511, 521 at one end and a griping section 512, 522 at another end; and a spring 54 having two ends respectively pushing against a corresponding portion of each of the two cutting members 51, 52.

For operation, a user holds and presses both of the griping sections 512, 522 together to cause the two cutting edge portions 511, 521 to move towards each other and then overlap along their edges, which then cuts off an object set between the edge portions 511, 521. When the user releases the two griping sections 512, 522, the elastic strength provided by the spring 54 pulls the two overlapping cutting edge portions 511, 512 apart from each other.

However, the typical garden shears has following drawbacks: the two cutting edge portions 511, 521 of the garden shears 50 are relatively rotated, and an opening formed by the two cutting edge portions 511, 521 has a V shape; therefore, during the cutting movement, the object placed between the two cutting edge portions 511, 512 can easily slide out of the V shaped opening causing difficulty.

Therefore, it is desirable to provide an improved garden shears structure to mitigate and/or obviate the aforementioned problems.

### SUMMARY OF THE INVENTION

An objective of the present invention is to provide improved garden shears structure.

In order to achieve the above-mentioned objectives, garden shears have a cutting member, a driving member, an elastic member and a blade. The cutting member has at least two casings, one end forming a handle and another end having an inverted U-shaped opening. The driving member is pivoted onto and sandwiched by the casings and has a griping section at one end and a central axis aperture at a predetermined position provided with a corresponding pivoting shaft for pivoting onto a corresponding aperture between the handle and the opening of the cutting member. The driving portion extends above the griping section, and a plurality of the first engaging teeth are formed along an upper edge of the driving portion. The elastic member has a circular section formed at a middle position and is pivoted onto the central axis aperture with the pivoting shaft, free ends of the elastic member respectively push against the handle and the griping section such that the driving member is pushed in a direction opposite that of the handle by the elastic member. A blade is disposed at a predetermined position of the cutting member and has a cutting edge portion on one side, and a plurality of second engaging teeth formed on a bottom side of the blade for engaging with the first engaging teeth of the driving member.

With the above-mentioned structure, the following benefits can be obtained: The cutting member has an inverted U-shaped opening for accepting the target object A; when the driving member is pushed towards the handle, the target object A in the opening is and pushed and cut off by the cutting edge portion of the blade. Therefore, the target object A can be securely limited by the garden shears without sliding off.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of an embodiment of the present invention.

FIG. 2 is an exploded view of an embodiment of the present invention.

FIG. 3 is a cross-sectional view of an embodiment of the present invention.

FIG. 4 illustrates use of an embodiment of the present invention.

FIG. 5 illustrates cutting movements of an embodiment of the present invention.

FIG. 6 is another drawing illustrating cutting movements of an embodiment of the present invention.

FIG. 7 is shows storing of an embodiment of the present invention.

FIG. 8 is a schematic drawing of a prior art device.

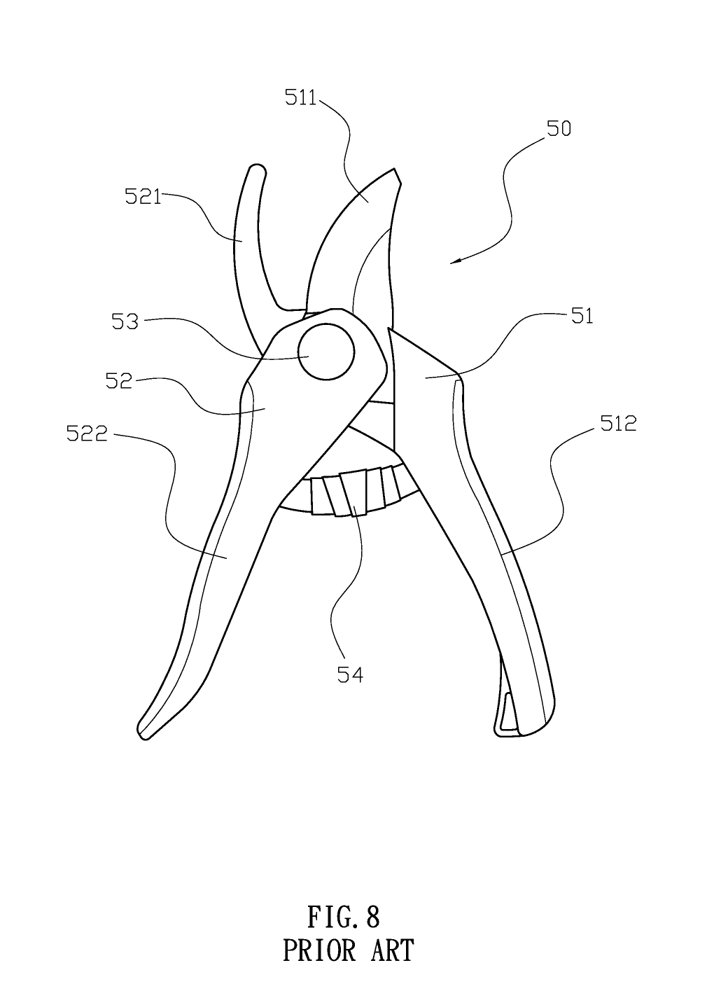

### DETAILED DESCRIPTION OF THE PREFERRED EMBODIMENT

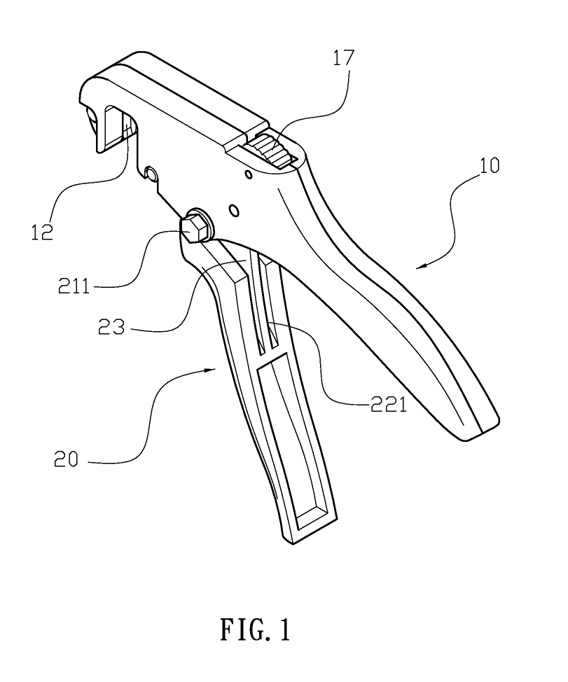

First, please refer to FIGS. 1, 2 and 3. A garden shears comprises a cutting member 10, a driving member 20, an elastic member 30 and a blade 40. The cutting member 10 has two casings 101, 102, one end forming a handle 11 and another end having an inverted U-shaped opening 12. The cutting member 10 further comprises a recessed containment space 13 for accepting the blade 40, the containment space 13 has a through opening 14 adjacent to the opening 12, and a stopping end 15 formed below and between the containment space 13 and the through opening 14. A supporting member 16 is disposed at a predetermined position through the cutting member 10 behind the containment space 13, and a positioning member 17 with a securing protrusion 171 is disposed onto the cutting member 10. The driving member 20 is pivoted onto and sandwiched by the casings 101, 102 and has a griping section 22 at one end and a central axis aperture 21 at a predetermined position provided with a corresponding pivoting shaft 211, for pivoting onto a corresponding aperture between the handle 11 and the opening 12 of the cutting member 10. A driving portion 23 extends above the griping section 22, a limiting space is formed between the griping section 22 and the driving portion 23 and a plurality of the first engaging teeth 231 are formed along an upper edge of the driving portion 23. The elastic member 30 has a circular section 31 formed at a middle position and is pivoted onto the central axis aperture 21 with the pivoting shaft 211, two free ends of the elastic member 30 respectively push against the handle 11 and the limiting space 221 of the griping section 22 such that the driving member 20 is pushed in a direction opposite that of the handle 11 by the elastic member 30. A blade 40 is disposed at a predetermined position of the cutting member 10 and has a cutting edge portion 41 on one side, an elongated aperture 42 corresponding to the supporting member 16 and parallel to a moving direction of the blade 40 is disposed in the blade 40. The cutting edge 41 of the blade 40 further comprises an engaging member 411 and a plurality of second engaging teeth 43 formed on a bottom side of the blade 40 for engaging with the first engaging teeth 231 of the driving member 20. Moreover, the blade further comprises a first positioning portion 44 with an indentation on an upper edge and a second positioning portion 45 at an end adjacent to the elongated aperture 42.

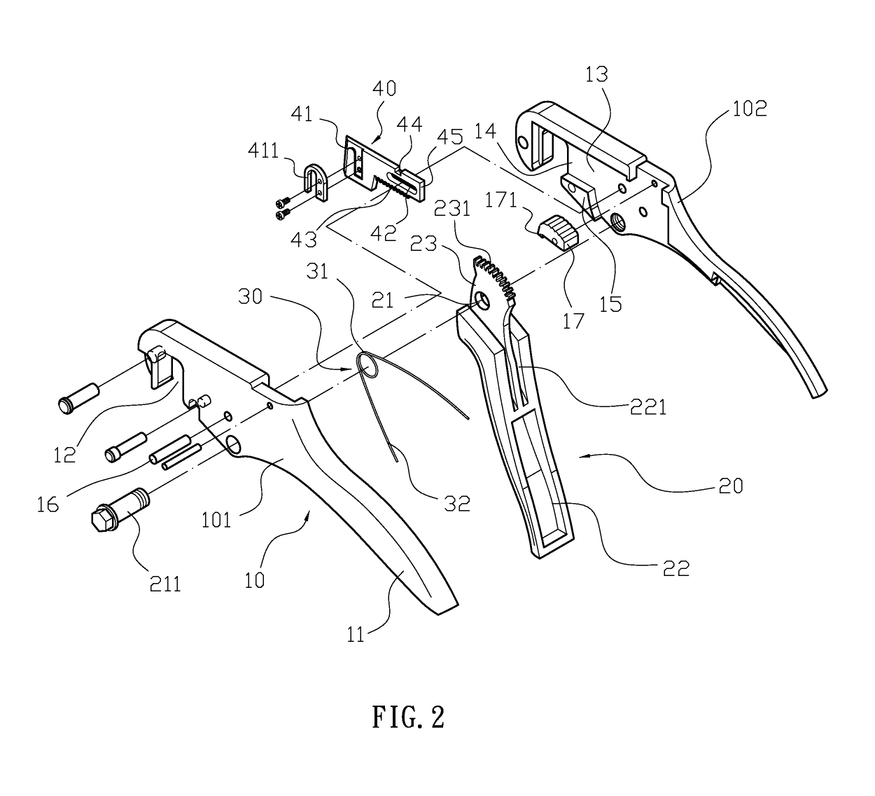

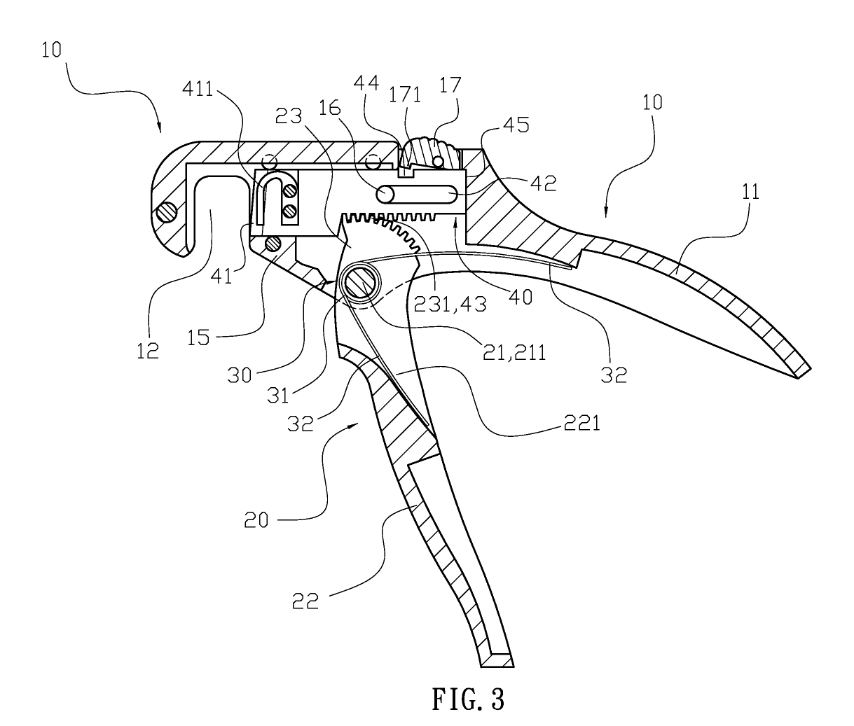

For assembly, please refer again to FIGS. 2 and 3. The blade 40 is disposed in the containment space 13 of the cutting member 10 formed by the two casings 101, 102. The cutting edge portion 41 of the blade 40 is placed to face the through opening 14 and the elongated aperture 42 is limited by the supporting member 16 against the stopping end 15. The driving member 20 utilizes the central axis aperture 21 to engage with the elastic member 30 in the containment space 13 of the cutting member 10 formed by the two casings 101, 102 and provides the pivoting shaft 211 passing through the cutting member 10 and central axis aperture 21. Two legs 32 of the elastic member 30 respectively push against the limiting space 221 of the driving member 20 and the handle 11 of the cutting member 10, such that the driving member 20 is pushed by the elastic member 30 to move away from the handle 11 of the cutting member 10. Furthermore, the driving portion 23 of the driving member 20 is accepted in the containment space 13 and utilizes the first engaging teeth 231 to engage with the second engaging teeth 43 of the blade 40. Therefore, when the driving member 20 and the handle 11 are pushed away from each by the elastic member 30, the blade 40 is driven by the driving portion 23 of the driving member 20 to move towards the handle 11.

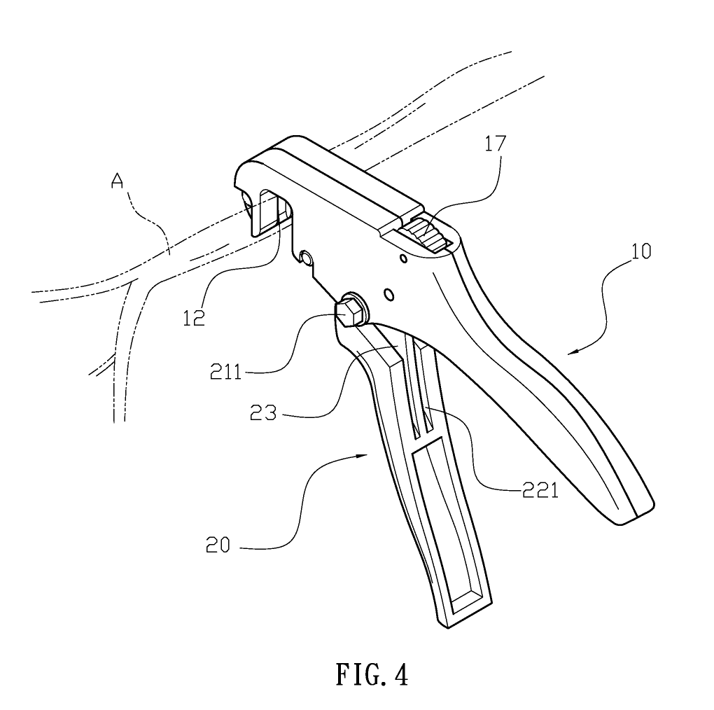

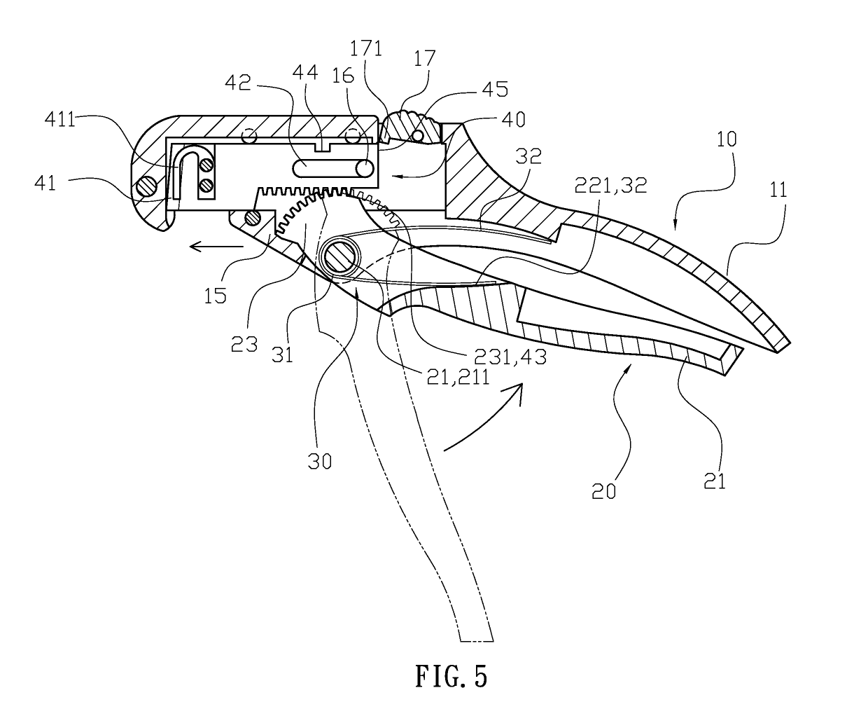

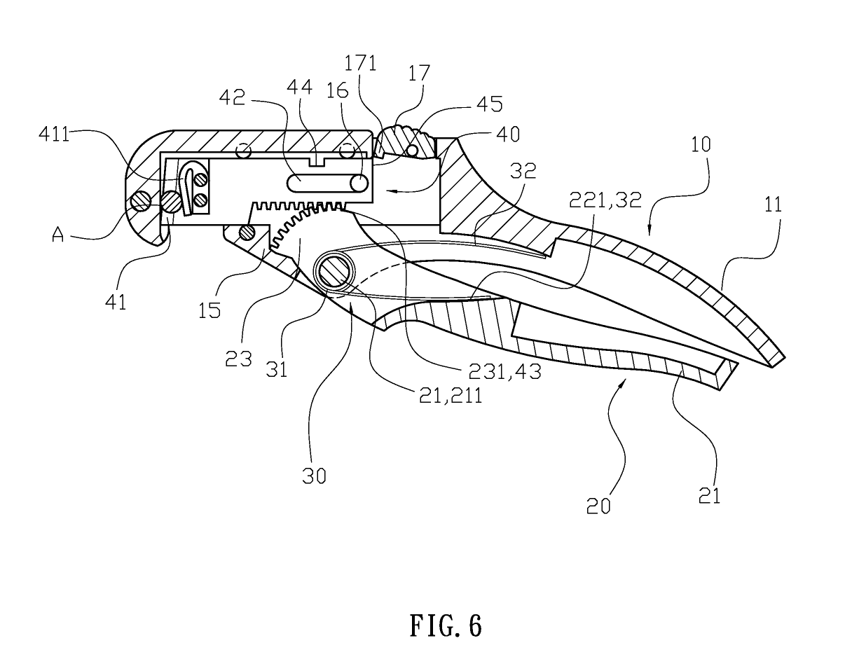

For actual operations, please refer to FIGS. 3-5. Usually, the driving member 20 of the garden shears is pushed away from the handle 11 by the elastic member 30, and the cutting edge portion 41 of the blade 40 is driven by the driving member 20 to be contained in the containment space 13. To use the garden shears, the opening 12 of the cutting member 10 needs to be hooked onto a target object A, and then the driving member 20 is pushed towards the handle 11 such that the driving portion 23 rotates around the pivoting shaft 211. With the first engaging teeth 231 driving the second engaging teeth 43 of the blade 40, since the blade 40 has a stroke distance based upon the elongated aperture 42, the blade 40 is driven by the driving member 20 to move toward to the opening 12 and pass through the through opening 14. Therefore, the target object A in the opening 12 is and pushed and cut off by the cutting edge portion 41 of the blade 40. Furthermore, the cutting edge portion 41 of the blade 40 has an engaging member 411, and the engaging member 411 contacts the target object A before the cutting edge portion 41 cuts through the target object A, as shown in FIG. 6, such that the cut-off target object A can be held between the engaging member 411 and the opening 12 instead of falling off.

Moreover, after the cutting movement, the driving member 20 is pushed away by the elastic member 30, and the first positioning portion 44 of the blade 40 is aligned with the positioning member 17 of the cutting member 10, as shown in FIG. 3. Therefore, the positioning member 17 can be pressed down to be limited within the first positioning portion 44, such that movement of the blade 40 is prevented and thus the driving member 20 cannot be moved to accidentally perform the cutting movement.

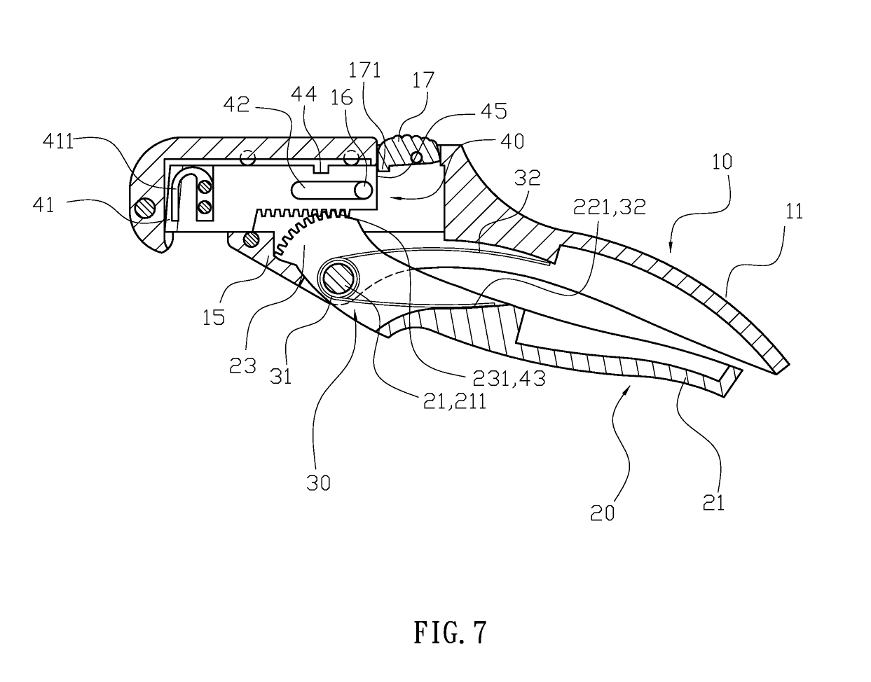

For storage of the garden shears, please refer to FIG. 7. The driving member 20 is pressed to be adjacent to the handle 11, such that the cutting edge portion 41 of the blade 40 passes through the opening 12 and against an inner sidewall of the cutting member 10. Furthermore, the second positioning portion 45 of the blade 40 moves away to be below the positioning member 17 of the cutting member 10, such that the positioning member 17 can be pressed down to push against an outer edge of the second positioning portion 45, to prevent the blade 40 from being ejected backwardly and prevent the driving member 20 from being pushed by the elastic member 30.

With the above-mentioned structure, the following benefits can be obtained: The cutting member 10 has an inverted U-shaped opening 12 for accepting the target object A; when the driving member 20 is pushed towards the handle 11, the target object A in the opening 12 is and pushed and cut off by the cutting edge portion 41 of the blade 40. Therefore, the target object A can be securely limited by the garden shears without sliding off.

Although the present invention has been explained in relation to its preferred embodiment, it is to be understood that many other possible modifications and variations can be made without departing from the spirit and scope of the invention as hereinafter claimed.

What is claimed is:

1. Garden shears comprising:
a cutting member having at least two casings, one end forming a handle and another end having an inverted U-shaped opening;
a driving member pivoted onto and sandwiched by the casings, having a griping section at one end and a central axis aperture at a predetermined position provided with a corresponding pivoting shaft, for pivoting onto a corresponding aperture between the handle and the opening of the cutting member;
a driving portion extending above the griping section, and a plurality of the first engaging teeth formed along an upper edge of the driving portion;
an elastic member having a circular section formed at a middle position and pivoted onto the central axis aperture with the pivoting shaft, free ends of the elastic member respectively pushing against the handle and the griping section such that the driving member is pushed in a direction opposite that of the handle by the elastic member; and
a blade disposed at a predetermined position of the cutting member and having a cutting edge portion on one side, and a plurality of second engaging teeth formed on a bottom side of the blade for engaging with the first engaging teeth of the driving member.

2. The garden shears as claimed in claim 1, wherein a supporting member is disposed at a predetermined position through the cutting member, and an elongated aperture corresponding to the supporting member and parallel to a moving direction of the blade is disposed in the blade.

3. The garden shears as claimed in claim 2, wherein the cutting member further comprises a recessed containment space for accepting the blade, the containment space having a through opening adjacent to the opening, and a stopping end is formed below and between the containment space and the through opening such that after the blade is disposed, the elongated aperture is limited by the supporting member against the stopping end.

4. The garden shears as claimed in claim 1, wherein the blade further comprises a first positioning portion with an indentation on an upper edge and a second positioning portion at an end adjacent to the elongated aperture, and a positioning member with a securing protrusion is disposed onto the cutting member.

5. The garden shears as claimed in claim 1, wherein a limiting space is formed between the griping section and the driving portion for accepting a side of the elastic member.

6. The garden shears as claimed in claim 1, wherein the cutting edge of the blade further comprises an engaging member.
